(19) United States
(12) Patent Application Publication
(10) Pub. No.: US 2025/0187049 A1
(43) Pub. Date: Jun. 12, 2025

(54) CLEANING DEVICE AND SYSTEM FOR PULL-IN OPERATIONS

(71) Applicant: PETRÓLEO BRASILEIRO S.A. – PETROBRAS, Rio de Janeiro (BR)

(72) Inventors: Victor DE OLIVEIRA MEIRELLES, Macaé (BR); Douglas Oliveira CORREA DE SOUZA, Macaé (BR); Andre Luiz BEVILAQUA SANTANA, Macaé (BR)

(21) Appl. No.: 18/971,683

(22) Filed: Dec. 6, 2024

(30) Foreign Application Priority Data
Dec. 9, 2023 (BR) 1020230259570

(51) Int. Cl. B08B 9/053

(52) U.S. Cl. CPC B08B 9/0535; B08B 2209/055

(57) ABSTRACT

The present disclosure discloses embodiments of a cleaning device and system for pull-in operations. An embodiment of a system presents: a topside unit comprising two hydraulic power units, a subsea manifold control station, a camera and light control station and a manipulator mechanism control unit; a control umbilical cable; a guide camera. In addition, an embodiment of a system includes the cleaning device for pull-in operations that presents: a pod; a manipulator mechanism; connection boxes; guide rollers; a high pressure pump; a subsea manifold; mechanical locks; a rack; a rack pump; side nozzles; and a magnetic support for attaching a mobile nozzle and a torque tool.

FIELD OF THE DISCLOSURE

The present disclosure pertains to the field of pull-in pre-operations, in which it is necessary to clean and soften the “dogs” (bend stiffener locking devices), for the arrival of a Pipeline Laying Support Vessel (PLSV) and coupling of the bend stiffener cap for subsequent installation of a flexible pipe.

### BACKGROUNDS OF THE DISCLOSURE

In subsea systems, the formation and proliferation of marine life is common, which becomes more evident in stationary structures, such as a Stationary Production Unit (SPU). This process involves an initial accumulation of microorganisms (microfouling), which allows the emergence of marine life on a larger scale, such as barnacles, bryozoans, sea squirts, sponges and macroalgae (macrofouling).

The presence of biofouling in marine units impairs the operability of procedures such as pull-in, as it can provide an additional layer of resistance or even prevent the cap from connecting to the bell mouth, due to the lack of mobility in the “dogs.”

Currently, to perform maintenance on the bell mouth and “dogs,” it is necessary to use a team of divers, which implies higher operational costs and a risk to the diver's life, considering the inclement weather and the unpredictability of sea conditions.

In this sense, the present disclosure presents a device operated remotely via topside that comprises mechanisms for both cleaning inside the tube and cleaning and loosening the “dogs,” by means of a mechanical arm that manipulates tools for this purpose.

### STATE OF THE ART

Some documents in the state of the art disclose technologies that fit the same objective as the present disclosure, in which, however, unresolved deficiencies still persist.

Document BR 10 2020 013190 A2 discloses an automated system for assisted cleaning and inspection of offshore tubular structures for removal and collection of biofouling residues. This system consists of three clamps, two for attachment to the tubular structure, with hydro jets (rotary and fixed) installed at the ends for cleaning intersections of the tubular structures, and a central clamp with hydro jets installed inside for cleaning the fixed or rigid tubular structure. The removal and collection of fouling occurs by means of suction pipes installed in the lower part of the central clamp, which is covered by a metal screen with a mesh size between 0 and 100 microns. The fouling undergoes a crushing process at the inlet of the suction pipe to reduce their size. The inspection occurs through underwater cameras and lights installed on the central clamp, and the system is moved by actuating a vertical piston (i). Unlike the present disclosure, document BR 10 2020 013190 A2 t aims at cleaning and inspecting cylindrical tubular structures that present external biofouling problems, without mentioning internal cleaning and maintenance of the “dogs” and bell mouths.

Document U.S. 2010139019 A describes an apparatus for cleaning the internal surfaces of large diameter pipelines by means of a structure adapted to clean a variety of pipe diameters. The apparatus uses an interlocked drive mechanism to develop the axial movement of the device and synchronize the rotary movement of the cleaning tips. The movement rate is adjustable to accommodate pipes of different diameters. In this way, the cleaning spray covers a strip of the pipe surface, with minimal overlap between passes, leaving no gaps in the cleaning. However, although document U.S. 20,101,39019 A describes the internal cleaning of a pipe by means of jetting, this document fails to present mechanisms to provide maintenance and cleaning of the “dogs” and bell mouths, according to the present disclosure.

Although the listed documents of the state of the art disclose systems and mechanisms for cleaning the interior and exterior of subsea tubular structures, none of the same come close to the present disclosure, as they fail to describe a system and device without a diver, operated via topside that removes biofouling from the bell mouth and ensures the mobility of the “dogs” for subsequent pull-in operation, thus avoiding the additional exposure of the diver.

### BRIEF DESCRIPTION OF THE DISCLOSURE

The present disclosure discloses embodiments of a cleaning device for pull-in operations comprising: a pod; a manipulator mechanism; connection boxes; guide rollers; a high pressure pump; a subsea manifold; mechanical locks; a rack; a rack pump; side nozzles; and a magnetic support for attaching a mobile nozzle and a torque tool.

In addition, the present disclosure also describes embodiments of a cleaning system for pull-in operations comprising: a topside unit comprising: two hydraulic power units, a subsea manifold control station, a camera and light control station and a manipulator mechanism control unit; a control umbilical cable; a guide camera; and the cleaning device in pull-in operations of the present disclosure.

### BRIEF DESCRIPTION OF THE FIGURES

To assist in the identification of the main features of the present disclosure, the figures to which references are made are presented, as follows:

FIG. 1A illustrates an exterior view of the device according to embodiments of the present disclosure.

FIG. 1B illustrates an interior view of the device of the present disclosure and its main components according to embodiments of the present disclosure.

FIGS. 2A illustrates an exemplary embodiment of the attachment of the device according to the present disclosure to a bell mouth.

FIG. 2B illustrates an exemplary embodiment of the removal of a mobile nozzle from the magnetized support by a manipulator mechanism according to the present disclosure.

FIG. 2C illustrates an exemplary embodiment of the jetting of “dogs” with the mobile nozzle according to the present disclosure.

### DETAILED DESCRIPTION OF THE DISCLOSURE

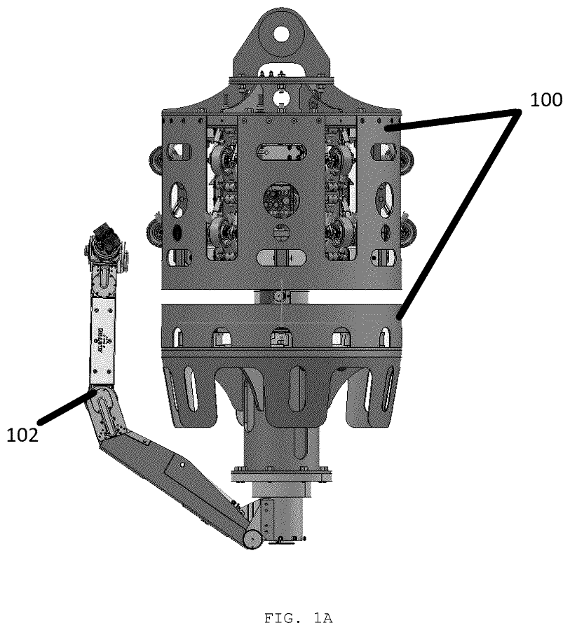

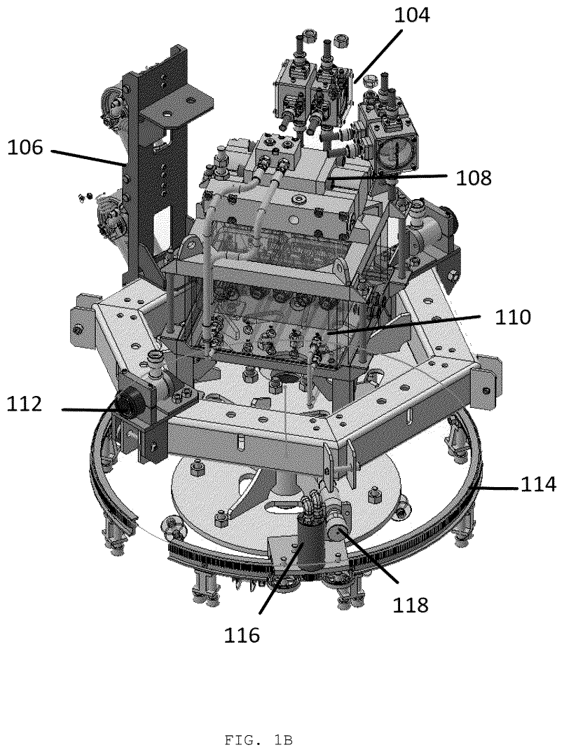

FIGS. 1A and 1B present construction

details of the cleaning device for pull-in operations of embodiments of the present disclosure. This device comprises: a pod (100); a manipulator mechanism (102); connection boxes (104); guide rollers (106); a high pressure pump (108); a subsea manifold (110); mechanical locks (112); a rack (114); a rack pump (116); side nozzles (118); a magnetic support for a mobile nozzle and a torque tool.

This device has four connection boxes (104), namely: two electrical connection boxes (CX-1, CX-2) connected to the subsea manifold (110); an optical-electrical connection box (CX-3) connected to the cameras (C1, C2), the lights (L1, L2) and the manipulator mechanism (102); and a telemetry connection box (CX-4) connected to the manipulator mechanism (102).

The electrical connection boxes (CX-1, CX-2) are connected to the topside by means of a PC connection cable and have the function of providing electrical power to the subsea manifold (110) and enabling the actuation of its servo valves (V1 to V5). The optical-electrical connection box (CX-3), in addition to providing electrical power and control for the cameras (C1, C2) and lights (L1, L2), is also responsible for sending the data captured by the cameras for viewing on the topside. Additionally, the telemetry connection box (CX-4) is connected to the topside by means of a telemetry connection cable, which allows the proportional valves of the manipulator arm to be controlled from the topside.

In this sense, on the topside of the SPU, there is installed the container where the device operation is performed. Inside this container, there are controlled all the cameras (C1 to C3), the lights (L1, L2), the servo valves (V1 to V5) of the subsea manifold (110), and the manipulator mechanism (102). In addition, there are two Hydraulic Power Units (HPU-1, HPU-2): HPU-1 for pressurizing the subsea manifold (110) and HPU-2 for pressurizing the manipulator mechanism (102). These connections between the topside and the device are made through a control umbilical between the device and the control on the topside.

HPU-1 pumps hydraulic fluid to the subsea manifold servo valves (V1 to V5), so that:
valve V1 connects to the high pressure pump (108), which pressurizes the valves of the side nozzles (V6) and the mobile nozzle (V7);
valve V2 actuates the side nozzles (118) and the mobile nozzle;
valve V3 actuates the rack pump, which rotates 180°, so that the side jets reach the entire circumference of the bell mouth;
valve V4 actuates the mobile torque tool/screwdriver in both directions; and
valve V5 actuates the mechanical lock.

In turn, HPU-2 supplies power to the seven servo valves (VP1 to VP7) of the manipulator mechanism (102), allowing the same to move around the bell mouth structure. In addition, to compensate for the hydrostatic pressure inside the servo valves (VP1 to VP7), there is an additional drain line inside each of the servo valves.

In an exemplary embodiment, the procedure for installing and preparing the cleaning device for pull-in operations entails the following steps:

After receiving the device of the present disclosure on the topside of a SPU, it must be positioned on a transport trolley and hoisted by a two-point hoisting assembly of the winch.

Then, the winch trolley must be displaced to align the same with the riser guide. With the device aligned with the riser guide, the manipulator mechanism must be articulated to avoid collisions with the riser guide and to ensure that it is properly locked by a stop on the guide. Once the device is locked, the two-point hoisting assembly must be removed, making way for a single-leg hoisting sling. With this, the stop structure can be removed, and the device launched towards the bell mouth.

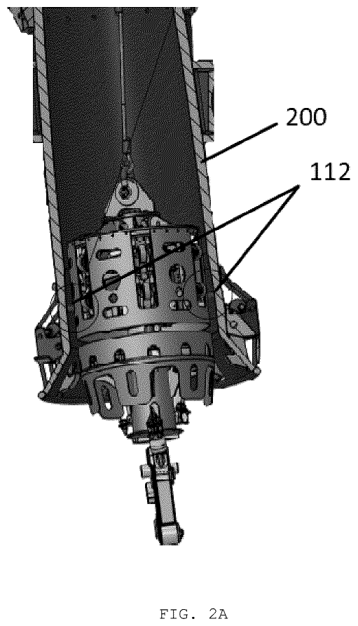

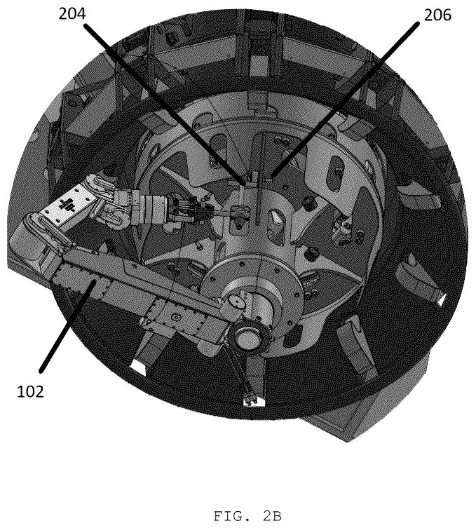

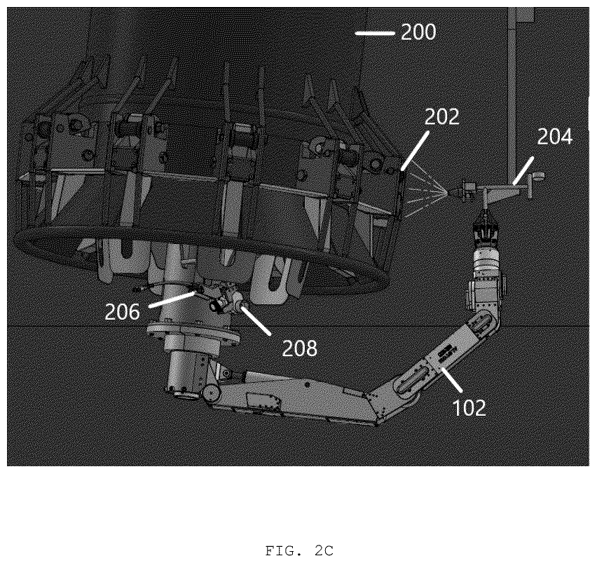

Upon entering the bell mouth, the operator on the topside can activate the side nozzles at the same time as activating the rack pump, to perform the jetting of the entire internal structure of the bell mouth, removing biofouling. As can be seen in FIG. 2A, after performing the internal cleaning procedure of the bell mouth (200), the operator, assisted by a remotely operated vehicle and a guide camera (C3) on top of the device, must actuate the mechanical locks (112) to anchor the device to the walls of the bell mouth in the correct position.

With the device properly anchored inside the bell mouth (200), the operator can use the manipulator mechanism (102) to capture a mobile nozzle (204) attached to the magnetic support (206) of the device and, with the help of cameras and lights, jet the “dogs” (202) of the bell mouth (200) with pressurized water, as presented in FIGS. 2B and 2C. Next, the operator must return the mobile nozzle to the magnetic support and take a torque tool (208) from this same support to loosen the “dogs” and check for interferences that prevent their correct operation. Once the inspection of all the “dogs” is complete, the torque tool must be returned to the support, the mechanical locks must be unlocked, and the device returned to the topside.

In this way, the system of the disclosure can be segmented between a topside portion, a control umbilical, and the cleaning device in pull-in operations. More specifically, the cleaning system in pull-in operations comprises:
a topside unit comprising: two hydraulic power units (HPU-1, HPU-2), a subsea manifold control station, a camera and light control station and a manipulator mechanism control unit;
a control umbilical; and
the cleaning device in pull-in operations of the present disclosure.

The control umbilical, in turn, comprises HPU-1 supply and return hoses; a PC connection cable; a CT connection cable; a telemetry connection cable; HPU-2 supply and return hoses; and the manipulator mechanism drain. CLAIMS

1. A cleaning device for pull-in operations, the cleaning device comprising:
a pod;
a manipulator mechanism;
connection boxes;
guide rollers;
a high pressure pump;
a subsea manifold;
mechanical locks;
a rack;
a rack pump;
side nozzles; and
a magnetic support for attaching a mobile nozzle (204) and a torque tool.

2. The cleaning device for pull-in operations according to claim 1, wherein in that the manipulator mechanism presents seven servo valves.

3. The cleaning device for pull-in operations according to claim 2, wherein that the manipulator mechanism presents a drain line inside each of the seven servo valves.

4. The cleaning device for pull-in operations according to claim 1, wherein that the subsea manifold presents five servo valves.

5. The cleaning device for pull-in operations according to claim 4, wherein that:
valve connects to the high pressure pump, which pressurizes the valves of the side nozzles and the mobile nozzle;
valve operates the side nozzles and the mobile nozzle;
valve activates the rack pump that rotates 180°;
valve activates the torque tool in both directions; and
valve activates the mechanical locks.

6. The cleaning device for pull-in operations according to claim 1, further comprising four connection boxes, namely:
two electrical connection boxes connected to the subsea manifold;
an optical-electrical connection box connected to the cameras, the lights, and the manipulator mechanism; and
a telemetry connection box connected to the manipulator mechanism.

7. A cleaning system for pull-in operations comprising:
a topside unit comprising: two hydraulic power units, a subsea manifold control station, a camera and light control station, and a manipulator mechanism control unit;
a control umbilical cable;
a guide camera; and
the cleaning device for pull-in operations as defined in claim 1.

8. The cleaning system for pull-in operation according to claim 7, wherein the connection boxes of the device are connected to the topside unit by means of connection cables.

9. The cleaning system for pull-in operation according to claim 7, wherein the HPU-1 pumps hydraulic fluid to the servo valves of the subsea manifold.

10. The cleaning system for pull-in operation according to claim 7, wherein the HPU-2 supplies the seven servo valves (VP1 to VP7) of the manipulator mechanism.

11. The cleaning system for pull-in operation according to claim 7, wherein the control umbilical cable comprises: HPU-1 supply and return hoses; a PC connection cable; a CT connection cable; a telemetry connection cable; HPU-2 supply and return hoses; and the manipulator mechanism drain.
